(19) United States
(12) Patent Application Publication
(10) Pub. No.: US 2008/0025908 A1
(43) Pub. Date: Jan. 31, 2008

(54) Method for extracting minerals with high purity from deep ocean water

(76) Inventors: Yong-Shik Chu, Gyeonggi-Do (KR); Tae-Myun Son, Gyeonggi-Do (KR)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/880,780

(22) Filed: Jul. 24, 2007

(30) Foreign Application Priority Data
Jul. 25, 2006 (KR) 10-2006-0069930

(51) Int. Cl. C01B 9/02

(52) U.S. Cl. 423/463

(57) ABSTRACT

A method for efficiently extracting minerals of high purity from deep ocean water by using low temperature vacuum crystal is disclosed. The method comprises the steps of: obtaining concentrated liquid containing ion components and fresh water without the ion components by freshening the deep ocean water; separating crystals of a calcium salt, a sodium salt, and a sulfate from the concentrated liquid by heat-concentrating and filtering the concentrated liquid; obtaining a mixed salt slurry of a potassium salt and a magnesium salt by concentrating the concentrated liquid from which a calcium salt, a sodium salt, and a sulfate are removed; obtaining a solution in which a magnesium salt is dissolved and a crystal of a potassium salt by washing the mixed salt slurry with water; and obtaining a mixed crystal of a potassium salt and a magnesium salt by concentrating the solution in which a magnesium salt is dissolved, and then separating a magnesium salt solution with improved purity by filtering the concentrated solution in which a magnesium salt is dissolved.

Minerals, as one of important five-nutrients for human beings, are used for forming body and regulating body function. A lack and surplus of minerals may retard physical and mental development and cause various diseases, and then it is important to maintain mineral balance. Calcium (Ca²⁺) is used in formation of bone and tooth, in function control of muscles, nerves, and heart, and in blood coagulation promotion. A lack of calcium causes constipation, osteoporosis, growth hindrance, convulsions, a decayed tooth, nervous anxieties, and so on. Magnesium (Mg²⁺) is used in energy generation, nerve function control, vitamin B and E metabolic promotion, and so on. A lack of magnesium causes heart diseases, hypertension, renal calculus, insomnia, arrhythmia, hypotension, appetite loss, muscular pain, anemia, and so on. Potassium (K⁺) is used in acid-base balance control, moisture control, nerve function maintenance, cell function preservation, blood vessel expansion, oxygen supply to brain, and so on. A lack of potassium causes arrhythmia, appetite loss, muscle convulsion, constipation, weariness, asthenia, hypoglycemia, and so on. Especially, a surplus of potassium is harmful to a renal insufficient patient.

Minerals of deep ocean water can be wholly soluble in water and have an advantage in good absorption by body, and accordingly is useful as minerals supplies for people today who have a trouble in mineral balance because of a bad food habits, environmental pollutions, and so on. However, the deep ocean water contains much salinity, so a freshening process of removing salinity from the deep ocean water is needed. In that process, useful minerals such as potassium, calcium, and magnesium can be removed together salinity.

A known method for refreshing process includes an evaporation method, a reverse osmotic membrane method, and an electrodialysis method. The evaporation method uses a principle that water of solvent in the ocean water is evaporated and solute remains by evaporating the ocean water. The reverse osmotic membrane method uses a principle that ion components dissolved in ocean water are filtered by a membrane (semipermeable membrane) which retains ion components dissolved in water and allows pure water to pass. In the electrodialysis method, a direct-voltage is supplied into cathode membrane and anode membrane disposed alternately, then cathode ion and anode ion are removed and therefore fresh water is obtained. However, in the above freshening method, it is difficult to efficiently separate various mineral components from the ocean water, so a recovery ratio is low. Especially it is difficult to efficiently separate potassium (K⁺) component and magnesium (Mg²⁺) component having the same ion charge as sodium ion (Na⁺)

### SUMMARY OF THE INVENTION

Therefore, it is an object of the present invention to provide a method for sorting and extracting minerals from the deep ocean water efficiently.

It is another object of the present invention to provide a method for extracting minerals with high purity.

It is still another object of the present invention to provide a method for extracting minerals with high recovery ratio of minerals.

To accomplish these objects, the present invention provides the method for extracting minerals, comprising the steps of obtaining concentrated liquid containing ion components and fresh water without the ion components by freshening the deep ocean water; separating crystals of a calcium salt, a sodium salt, and a sulfate from the concentrated liquid by heat-concentrating and filtering the concentrated liquid; obtaining a mixed salt slurry of a potassium salt and a magnesium salt by concentrating the concentrated liquid from which a calcium salt, a sodium salt, and a sulfate are removed; obtaining a solution in which a magnesium salt is dissolved and a crystal of a potassium salt by washing the mixed salt slurry with water; and obtaining a mixed crystal of a potassium salt and a magnesium salt by concentrating the solution in which a magnesium salt is dissolved, and then separating a magnesium salt solution with improved purity by filtering the concentrated solution in which a magnesium salt is dissolved.

### BRIEF DESCRIPTION OF THE DRAWINGS

FIG. 1 is a drawing for illustrating a method for extracting minerals according to an embodiment of the present invention.

FIG. 2 is a drawing for illustrating a structure of a triple effect evaporator used in a method for extracting minerals according to an embodiment of the present invention.

FIG. 3 is a drawing for illustrating a method for extracting minerals according to another embodiment of the present invention.

### DETAILED DESCRIPTION OF THE INVENTION

A more complete appreciation of the invention, and many of the attendant advantages thereof, will be better appreciated by reference to the following detailed description.

Deep ocean water used in the present invention, are obtained from seawater at the depth of 200 m and below, and has a plenty of ion components including sodium ion (Na⁺), potassium ion (K⁺), calcium ion (Ca²⁺), magnesium ion (Mg²⁺), boron ion (B³⁺), chlorine ion (Cl⁻), carbonic acid ion (CO₃²⁻), sulfuric acid ion (SO₄²⁻), and so on. In general, 1 L of deep ocean water contains 10,500 mg of sodium (Na⁺) component, 1,350 mg of magnesium (Mg²⁺) component, 400 mg of calcium (Ca²⁺) component, 380 mg of potassium (K⁺) component, and 4.6 mg of boron (B³⁺) component. The components form various inorganic salts such as calcium carbonate (CaCO₃), calcium sulfate (CaSO₄), calcium sulfate hydroxide (CaSO₄.2H₂O), sodium chloride (NaCl), magnesium sulfate (MgSO₄), potassium chloride (KCl), magnesium chloride hydroxide (MgCl₂.2H₂O), and so on according to temperature of seawater and solubility. To extract minerals from the deep ocean water, at first the deep ocean water is freshened to obtain concentrated liquid containing ion components and fresh water without the ion components. As a freshening process, an evaporation method, a reverse osmotic membrane method, and an electrodialysis method can be used, and it is preferable to use the reverse osmotic membrane method in which concentrated liquid containing ion components and fresh water without the ion components are separated by passing the deep ocean water into the reverse osmotic membrane. In general, 1 L of the concentrated liquid contains 20,000 to 23,000 mg of sodium (Na⁺) component, 1,900 to 2,100 mg of magnesium (Mg²⁺) component, 600 to 670 mg of calcium (Ca²⁺) component, 630 to 700 mg of potassium (K⁺) component, and 6 to 7 mg of boron (B³⁺) component.

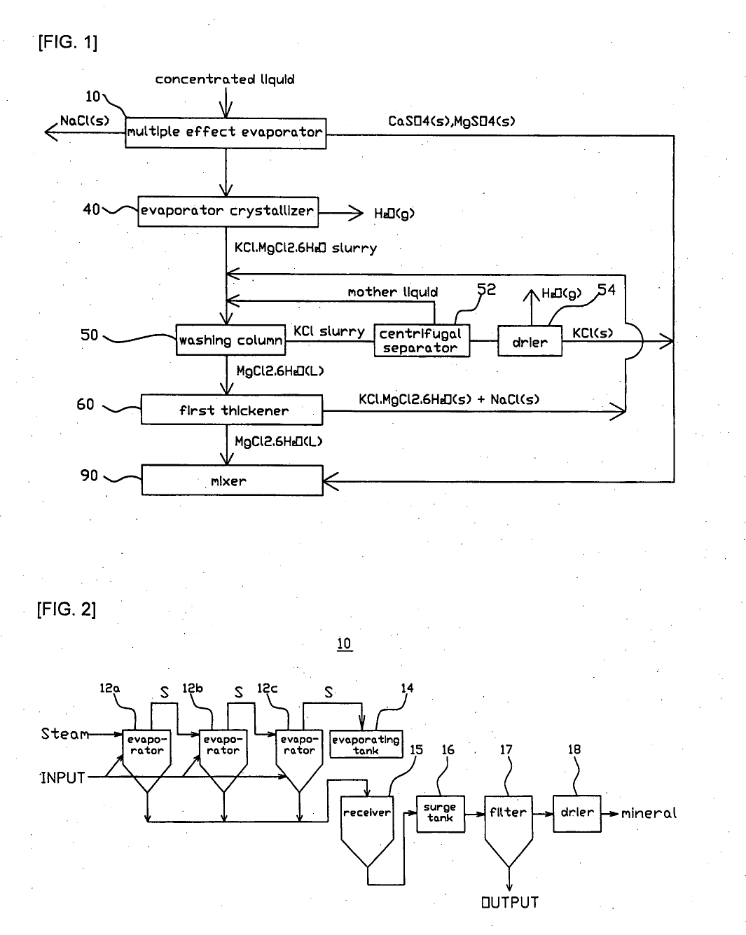

FIG. 1 is a drawing for showing a method for extracting minerals according to an embodiment of the present invention. As shown in FIG. 1, to extract minerals according to the present invention, by using an evaporator such as a multiple effect evaporator 10, the concentrated liquid is heat-concentrated and filtered to separate crystals of a calcium salt, a sodium salt, and a sulfate. In that process, the calcium salt is extracted in the forms of calcium carbonate (CaCO₃), calcium sulfate (CaSO₄), and so on, and the sodium salt is extracted in the form of sodium chloride (NaCl), and the sulfate is extracted mainly in the form of magnesium sulfate (MgSO₄). The separation process of crystals of a calcium salt, a sodium salt, and a sulfate is on a basis that the inorganic salts, that is minerals, are sequentially crystallized as being heat-concentrated. The degree of heat concentration for the concentrated liquid may be measured as degree Baume (° Be). The Baume (° Be) degree is a hydrometer scale to measure density of various liquids in floating a Baume's hydrometer onto the liquid. There are two types of the Baume's hydrometer for liquids heavier than water and for liquids lighter than water, and the Baume's hydrometer used in the present invention is the Baume's hydrometer for liquid heavier than water, manufactured by Daekwang instrument Co., Ltd. In the Baume's hydrometer for liquid heavier than water, 0° Be is distance the hydrometer sinks in pure water and 15° Be is distance the hydrometer sinks in a solution that is 15% sodium chloride (salt, NaCl) by mass, and the distance between 0° Be and 15° Be is divided by 15. In case of seawater, because the degree Baume (° Be) is similar to salt concentration (wt %), the degree Baume (° Be) can be used as a scale for concentration of the ocean water. The relationship between a specific gravity of liquid and the degrees Baume (° Be) is known as “d=144.3÷(144.3−° Be)”, for liquids heavier than water.

The multiple effect evaporator 10, an apparatus for extracting and separating crystals of a calcium salt, a sodium salt, and a sulfate from the concentrated liquid, operates on a basis of that there is difference of salt solubility and a boiling point becomes low at low pressure. Therefore, at low pressure, preferably at vacuum, the concentrated liquid is evaporatured and concentrated by passing a high temperature steam so that each of salts become extracted. As the multiple effect evaporator 10, a triple effect evaporator where three evaporator is connected one after another can be used, and the number of multiple effect evaporator 10 used can be varied according to types of obtained inorganic salts. FIG. 2 is a drawing for showing a structure of a triple effect evaporator in a method for extracting minerals according to an embodiment of the present invention. As shown in FIG. 2, in the triple effect evaporator, the three evaporator 12a, 12b, 12c are connected one after another, and a evaporating tank 14 is connected to one end of the third evaporator 12c to induct a steam flow. The lower part of each evaporator 12a, 12b, 12c is connected with a receiver 15, and the receiver 15 is connected with a surge tank 16, and the surge tank 16 is connected with a filter 17. Each evaporator 12a, 12b, 12c is in the low pressure. A high temperature steam flows into the first evaporator 12a, and the steam occurred in the first evaporator 12a is fed into the second evaporator 12b, and the steam occurred in the second evaporator 12b is fed into the third evaporator 12c and eventually flows to the evaporating tank 14. The concentrated liquid is flowed into each evaporator 12a, 12b, 12c, and a solvent is evaporated and concentrated in each evaporator 12a, 12b, 12c. Eventually, an inorganic salts of low solubility becomes crystallized, and the degree Baume (° Be) of the concentrated liquid increases. The crystallized inorganic salts and the concentrated liquid of the increased degree Baume (° Be) pass through the receiver 15, the surge tank 16, and the filter 17, and in the filter 17, eventually is separated into the crystallized inorganic salts and the concentrated liquid without the crystallized inorganic salts. The separated inorganic salts are dried at a drier 18, and the separated concentrated liquid is used on the following process. The multiple effect evaporator 10 generally is disposed according to the kind of obtained inorganic salts. So in this embodiment, three multiple effect evaporators 10 can be used in sequence so as to separate and obtain a calcium salt, a sodium salt, and a sulfate. Namely, in the first multiple effect evaporator, a calcium salt of relatively low solubility is separated, and in the second multiple effect evaporator, a sodium salt is separated, and at last, in the third multiple effect evaporator, a sulfate of relatively high solubility is separated.

The separating process of a calcium salt, a sodium salt, and a sulfate will be described below in detail. A concentrated liquid (Brine) of 4.5° Be obtained from seawater is fed into the first triple effect evaporator, and is evaporated and concentrated up to a concentrated liquid of 20 to 25° Be in the first triple effect evaporator, to extract a crystal of a calcium salt. The crystal of a calcium salt is removed in the filter 17. The concentrated liquid of 20 to 25° Be without a calcium salt crystal is fed into the second triple effect evaporator. In the second triple effect evaporator, the concentrated liquid of 20 to 25° Be is evaporated and concentrated up to a concentrated liquid of 29 to 32° Be, to extract a crystal of a sodium salt. The crystal of a sodium salt is removed by the filter 17. The concentrated liquid of 29 to 32° Be is inserted into the third triple effect evaporator. In the third triple effect evaporator, the concentrated liquid of 29 to 32° Be is evaporated and concentrated up to a concentrated liquid of 35 to 37° Be, to extract a crystal of a sulfate. Like this, by using a number of multiple effect evaporators 10, a needed inorganic salt may be separated in sequence. As occasion demands, by using a single multiple effect evaporator 10, a concentrated liquid of 4.5° Be can be concentrated up to a concentrated liquid of 29 to 32° Be and a calcium salt, a sodium salt, a sulfate can be extracted and removed at once. In the separating process of a calcium salt, a sodium salt, and a sulfate, it is preferable that the evaporation-concentration process progresses slowly together a stirring operation. If the degree Baume is less than the above range in the each separating process, the crystal of inorganic salts such as a calcium salt, a sodium salt, and a sulfate can be extracted insufficiently. If the degree Baume is more than the above range, another inorganic salts except for a calcium salt, a sodium salt, and a sulfate can be extracted. The obtained calcium salt and magnesium salt can be used in the production of mineral water, and the obtained sodium salt can be used as another application such as a purified salt or disused.

The concentrated liquid from which a calcium salt, a sodium salt, and a sulfate are removed, is fed into an evaporator crystallizer 40, and is concentrated to produce a mixed salt slurry of a potassium salt and a magnesium salt. The mixed salt slurry of a potassium salt and a magnesium salt is in the form of potassium chloride.magnesium chloride.6hydrate (KCl.MgCl₂.6H₂O) slurry. The evaporator crystallizer 40 evaporates water (solvent) included in the concentrated liquid, at a low pressure, preferably at a pressure of 10 to 20 mmHg and at a temperature of 45 to 55° C. to obtain the mixed salt slurry of a potassium salt and a magnesium salt. If the pressure and temperature is more than the above range, yield ratio may be degraded. If the pressure and temperature is less than the above range, boiling of a concentrated liquid may be insufficient. In the mixed salt slurry of a potassium salt and a magnesium salt, an amount of water is preferably about 5 to 50 weight % with respect to the total slurry. If the amount of water is less than the above range, the fluidity may be low excessively. If the amount of water is more than the above range, the reaction may be insufficient and the yield ratio may be degraded. Inside of the evaporator crystallizer 40 maintains at low pressure, and a boiling point of solvent becomes low and solubility of inorganic salts becomes low. With stirring operation, the solution becomes supersaturated and particles become big. Because the above process operates at a low temperature and a vacuum, the yield ratio of a potassium chloride.magnesium chloride.6hydrate (KCl.MgCl₂.6H₂O) will increase up to 76% (namely, by obtaining through crystallization of 76% of total potassium chloride.magnesium chloride.6hydrate (KCl.MgCl₂.6H₂O)) and operation time will be short and energy cost will decrease and also operation will be easy as well as the process will be simple.

Next, the mixed salt slurry of a potassium salt and a magnesium salt is fed into a washing column 50 and is washed by water, and then a solution in which a magnesium salt is dissolved and a crystal of a potassium salt, are obtained. Namely, when potassium chloride.magnesium chloride.6hydrate (KCl.MgCl₂.6H₂O) slurry is fed into the washing column 50 and is washed with water, a solution containing much of magnesium chloride.6hydrate (MgCl₂.6H₂O) and a crystal of a potassium chloride in the form of slurry are obtained. The crystal of a potassium chloride (KCl) in the form of slurry is transferred into a centrifugal separator 52 and then mother liquid of the slurry is removed and is dried in a drier 54 and eventually a crystal of a potassium chloride (KCl) as solid is obtained. The removed mother liquid can be fed into the washing column 50. Using such a washing column 50 has an advantage in that a purity of a potassium salt will increase up to 99.5% and subsequent processes will be possible. There is specially no limit about washing water, but sterilized distilled water, de-ion water, fresh water from seawater, and so on may be used. Amount of washing water will be amount enough to melt and remove the magnesium salt sufficiently.

Next, the solution in which a magnesium salt is dissolved is dehydrated and concentrated in a first thickener 60. A dehydration and concentration process in the first thickener 60 are performed by inflowing the solution in which a magnesium salt is dissolved into a feed pipe and by rotating the feed pipe wherein lighter part of the solution is pushed out and heavier extractor part in the form of slurry remains in a rotation center of the feed pipe by a centrifugal force. Like this, when the solution in which a magnesium salt is dissolved is concentrated, a mixed crystal of a potassium salt and a magnesium salt and a crystal of sodium chloride are extracted as by-product and also a purity of magnesium in the solution in which a magnesium salt is dissolved increases. In general, a solution with a magnesium salt dissolved which is obtained in a first thickener 60 contains about 17.5 weight % of a magnesium chloride (MgCl₂) and 50 weight % of water. Accordingly, when a magnesium salt solution is filtered and by-product is removed, a magnesium salt solution of improved purity is separated and obtained. Namely, the first thickener 60 concentrates the magnesium chloride.6hydrate (MgCl₂.6H₂O) solution containing a small quantity of a potassium salt (KCl), thus to extract a mixed crystal of a potassium chloride.magnesium chloride.6hydrate (KCl.MgCl₂.6H₂O) and a crystal of a sodium chloride (NaCl) as by-product, and to improve the purity of the magnesium chloride.6hydrate (MgCl₂.6H₂O) solution. The separated crystal of a potassium chloride.magnesium chloride.6hydrate (KCl.MgCl₂.6H₂O) and a crystal of a sodium chloride (NaCl) can be supplied to the washing column 50, with the mixed salt slurry of a potassium salt and a magnesium salt obtained in the evaporator crystallizer 40 whenever necessary. Therefore, the yield ratio for minerals of a potassium salt and a magnesium salt will become improved again by separating a potassium salt and a magnesium salt contained in a potassium chloride.magnesium chloride.6hydrate (KCl.MgCl₂.6H₂O) crystal. Like this, the yield ratio for a potassium salt and a magnesium salt becomes improved through a circulation and reuse of the potassium chloride.magnesium chloride.6hydrate (KCl.MgCl₂.6H₂O).

The separated inorganic salts will be used for production of mineral beverages by being added to fresh water obtained from seawater. The mixture of the inorganic salts and fresh water may be performed in a mixer 90, and then a mineral balance of the mineral beverages will be adjustable by mixing the calcium salt obtained in the multiple effect evaporator 10, the potassium salt obtained in the washing column 50, and the magnesium salt obtained in the first thickener 60.

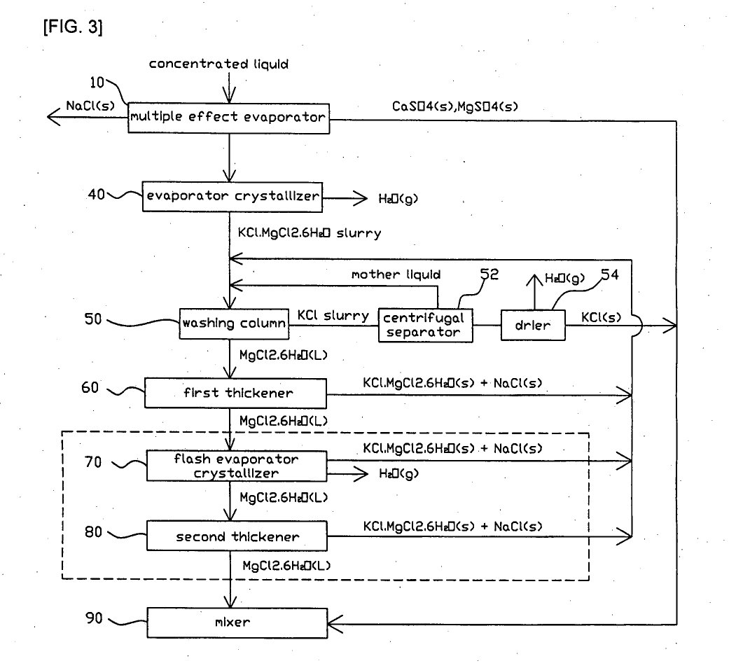

FIG. 3 is a drawing for showing a method for extracting minerals according to another embodiment of the present invention. As shown in FIG. 3, to improve purity of magnesium salt, a flash evaporator crystallizer 70 and a second thickener 80 are used additionally. The flash evaporator crystallizer 70 uses a flash process that water is removed in the form of vapor state by flashily transferring the magnesium salt solution of improved purity obtained in the first thickener 60 from high-pressure field to low-pressure field. At this time, it is preferable that the temperature in the low-pressure field is higher than that in the high-pressure field. Also, it is possible to adjust amounts of water evaporating, by regulating amounts of solution flowed into the high-pressure field and the temperature and pressure difference between the high-pressure field and the low-pressure field. Like this, the solution of a magnesium salt obtained in the flash evaporator crystallizer 70 has higher purity of magnesium chloride.6hydrate (MgCl₂.6H₂O) than the solution of a magnesium salt obtained in the first thickener 60. The mixed crystal of a potassium chloride.magnesium chloride.6hydrate (KCl.MgCl₂.6H₂O) and the crystal of a sodium chloride (NaCl) as by-product are obtained. In the flash evaporator crystallizer 70, it is preferable to dehydrate water of the magnesium salt solution at a state of high vacuum. While a solubility of a sodium chloride (NaCl) is 35.9 and a solubility of a potassium chloride.magnesium chloride.6hydrate (KCl.MgCl₂.6H₂O) is 64.5, a solubility of a magnesium chloride.6hydrate (MgCl₂.6H₂O, solubility-400) is much higher than a sodium salt and a potassium chloride.magnesium chloride.6hydrate. So, the magnesium chloride.6hydrate (MgCl₂.6H₂O) is melted in a solution largely.

The second thickener 80 dehydrates and concentrates the solution containing magnesium chloride.6hydrate (MgCl₂.6H₂O) obtained in the flash evaporator crystallizer 70, to extract a crystal of potassium chloride.magnesium chloride.6hydrate (KCl.MgCl₂.6H₂O) and a crystal of sodium chloride (NaCl), and then to produce improved purity of solution of magnesium chloride.6hydrate (MgCl₂.6H₂O). The same as the first thickener 60 will be used as the second thickener 80. The obtained crystals of potassium chloride.magnesium chloride.6hydrate (KCl.MgCl₂.6H₂O) and sodium chloride (NaCl) may be re-fed to the washing column 50 so as to improve yield ratio for a potassium salt and a magnesium salt. The obtained minerals will be used for example in production of mineral water.

Hereinafter, the preferable examples are provided for better understanding of the present invention. However, the present invention is not limited to the following examples.

### EXAMPLE

The deep ocean water is closely filtered with a micro filter (Polytetrafluoroethylene(PTFE), about 0.5 μm of hole size, product of Saehan Co., Ltd) to remove impurities therefrom (pre-treatment process). By using a reverse osmotic system (product of Dow Chemical Company, FILMTEC, SW30-4021, 0.5 of yield ratio), the deep ocean water was separated into concentrated liquid and fresh water. Amounts (unit-GPD(gallon per day)) of the deep ocean water, the pre-treated water and the concentrated liquid and density of minerals (unit-mg/l) are represented in Table 1, and a degree Baume for the obtained concentrated liquid was 4.5° Be.

TABLE 1

| | Deep ocean | Pre-treated | Concentrated |
|---|---|---|---|
| | water | water | liquid |
| Amount(GPD) | 1722.4 | 1722.4 | 932.26 |
| Na(mg/l) | 14000 | 14000 | 26831 |
| Ca(mg/l) | 410 | 410 | 785.8 |
| Mg(mg/l) | 1300 | 1255 | 2491 |
| K(mg/l) | 430 | 430 | 824.1 |
| B(mg/l) | 4.2 | 4.2 | 8.05 |
| S(mg/l) | 820 | 820 | 1571 |

By sequentially passing the concentrated liquid into three multiple effect evaporator (10, in FIG.1), a calcium salt, a sodium salt, and a sulfate were sequentially separated and removed on a state of that the degree Baume of the concentrated liquid became 23° Be, 30° Be, and 36° Be. Next, the concentrated liquid from which a calcium salt, a sodium salt, and a sulfate were removed, was fed into a evaporator crystallizer 40 and was concentrated at 15 mmHg of pressure and 50° C. of temperature, and then a mixed salt slurry of a potassium salt and a magnesium salt was obtained. The mixed salt slurry was fed into a washing column 50, and was washed with water, and then the solution of a magnesium salt and the slurry containing crystal of a potassium salt (KCl) were obtained. The potassium chloride (KCl) slurry was centrifuged and dried, and then a crystal of potassium chloride was obtained as solid state. Also, a thickener 60 dehydrated and concentrated the solution in which the magnesium salt is dissolved, to extract the mixed crystals of a potassium salt and a magnesium salt and a crystal of sodium chloride (NaCl) and remove them from the solution of magnesium salt, and to obtain a solution of magnesium chloride.6hydrate (MgCl₂.6H₂O) of improved purity of magnesium salt. In the solution of magnesium chloride.6hydrate (MgCl₂.6H₂O) as final products, a density of magnesium chloride.6hydrate (MgCl₂.6H₂O) was 35.2 weight % and a density of other inorganic salts was about 3.2 weight %, and after all, it could be known that a magnesium salt solution of improved purity became obtained.

As described above, a method for extracting minerals according to the present invention can separate and efficiently extract minerals from the deep ocean water, and especially a method for extracting minerals has an advantage that a magnesium salt and a potassium salt of high purity can be obtained. In addition, the method for extracting minerals according to the present invention can improve yield ratio and production efficiency of minerals, by reusing mixed salts of minerals, by-products, in a process for extracting minerals.

1. A method for extracting minerals from deep ocean water, comprising the steps of:
obtaining concentrated liquid containing ion components and fresh water without the ion components by freshening the deep ocean water;
separating crystals of a calcium salt, a sodium salt, and a sulfate from the concentrated liquid by heat-concentrating and filtering the concentrated liquid;
obtaining a mixed salt slurry of a potassium salt and a magnesium salt by concentrating the concentrated liquid from which a calcium salt, a sodium salt, and a sulfate are removed;
obtaining a solution in which a magnesium salt is dissolved and a crystal of a potassium salt by washing the mixed salt slurry with water; and
obtaining a mixed crystal of a potassium salt and a magnesium salt by concentrating the solution in which a magnesium salt is dissolved, and then separating a magnesium salt solution with improved purity by filtering the concentrated solution in which a magnesium salt is dissolved.

2. The method for extracting minerals of claim 1, wherein the crystals of a calcium salt, a sodium salt, and a sulfate are sequentially separated by using three multiple-effect evaporators.

3. The method for extracting minerals of claim 1, wherein the mixed salt slurry of a potassium salt and a magnesium salt is a potassium chloride.magnesium chloride.6hydrate(KCl.MgCl₂.6H₂O) slurry, and are obtained by evaporating water contained in the concentrated liquid at a pressure of 10 to 20 mmHg and a temperature of 45 to 55° C.

4. The method for extracting minerals of claim 1, wherein the washing process of the mixed salt slurry is carried out in a washing column.

5. The method for extracting minerals of claim 1, wherein a crystal of sodium chloride is generated together with the mixed crystal of a potassium salt and a magnesium salt.

6. The method for extracting minerals of claim 1, wherein the mixed crystal of a potassium salt and a magnesium salt is fed into the washing process together with a mixed salt slurry of a potassium salt and a magnesium salt.

7. The method for extracting minerals of claim 1, further comprising the steps of extracting a crystal of potassium chloride.magnesium chloride.6hydrate and a crystal of sodium chloride, and obtaining a solution of magnesium chloride.6hydrate having more improved purity by dehydrating and concentrating the magnesium salt solution having improved purity.
